(19) United States
(12) Patent Application Publication
(10) Pub. No.: US 2014/0169481 A1
(43) Pub. Date: Jun. 19, 2014

(54) SCALABLE HIGH THROUGHPUT VIDEO ENCODER

(71) Applicant: ATI TECHNOLOGIES ULC, Markham (CA)

(72) Inventors: Lei Zhang, Richmond Hill (CA); Ying Luo, Richmond Hill (CA); Edward A. Harold, Scarborough (CA)

(73) Assignee: ATI TECHNOLOGIES ULC, Markham (CA)

(21) Appl. No.: 13/720,546

(22) Filed: Dec. 19, 2012

(51) Int. Cl. H04N 7/26

(52) U.S. Cl. CPC H04N 19/00424
USPC 375/240.24

(57) ABSTRACT

A scalable high throughput video encoder is described herein. A plurality of dedicated, hardware video encoders runs in a staggered, parallel architecture, where each video encoder encodes a video frame and the stagger or delay is a programmable number of macroblock rows. In an example method, after a first video encoder finishes encoding the first x macroblock rows of a frame, the first video encoder signals a second video encoder to start encoding a macroblock row of a next unprocessed frame. Both video encoders continue encoding in parallel in a synchronized, staggered manner. At the end of the frame, the first video encoder starts encoding x macroblock rows of another unprocessed frame.

### FIELD

The present disclosure is generally directed to encoding, and in particular, to video encoding.

### BACKGROUND

The transmission and reception of video data over various medium is ever increasing. Typically, video encoders are used to compress the video data and reduce the amount of video data transmitted over the medium. Traditional video encoding applications such as wireless displays or high definition video conferencing requires only modest throughput, such as 1080p at 30 frames per second (fps) or 1080p at 60 fps.

High throughput video encoding is critical for high-performance video transcoding or cloud gaming applications. Often, in video transcoding applications, a two hour movie needs to be transcoded in a few minutes, or at least in a few tens of minutes. In cloud gaming applications, multiple sessions of game rendering needs to be encoded before they can be transmitted across a network, for example, over the Internet or an Intranet. The high performance video transcoding and cloud gaming applications require a few multiples of 1080p at 30 fps or 1080p at 60 fps. This provides a scalability challenge for hardware video encoders to support a high throughput. Some implementations have resorted to hybrid approaches where part of the encoding of a video frame is completely done in a 3D shader, (which uses the central processing unit or graphics processing unit), while the rest of the encoding of a frame is done on fixed function hardware.

### SUMMARY

A scalable high throughput video encoder is described herein. A plurality of dedicated, hardware video encoders runs in a staggered, parallel architecture, where each video encoder encodes a video frame and the stagger or delay is a programmable number of macroblock rows. In an example method, after a first video encoder finishes encoding the first x macroblock rows of a frame, the first video encoder signals a second video encoder to start encoding a macroblock row of a next unprocessed frame. Both video encoders continue encoding in parallel in a synchronized staggered manner. At the end of the frame, the forst video encoder starts encoding x macroblock rows of another unprocessed frame.

### BRIEF DESCRIPTION OF THE DRAWINGS

A more detailed understanding may be had from the following description, given by way of example in conjunction with the accompanying drawings wherein:

FIG. 1 is an example system architecture that uses high throughput video encoders, according to some embodiments;

FIG. 2 is an example high throughput video encoder, according to some embodiments;

FIG. 3 is an example diagram of frames and macroblock rows;

FIG. 4 is an example flowchart for encoding video data using high throughput video encoders, according to some embodiments;

FIG. 5 is another example flowchart for encoding video data using high throughput video encoders, according to some embodiments; and

FIG. 6 is a block diagram of an example source or destination device for use with embodiment of the high throughput video encoders, according to some embodiments.

### DETAILED DESCRIPTION

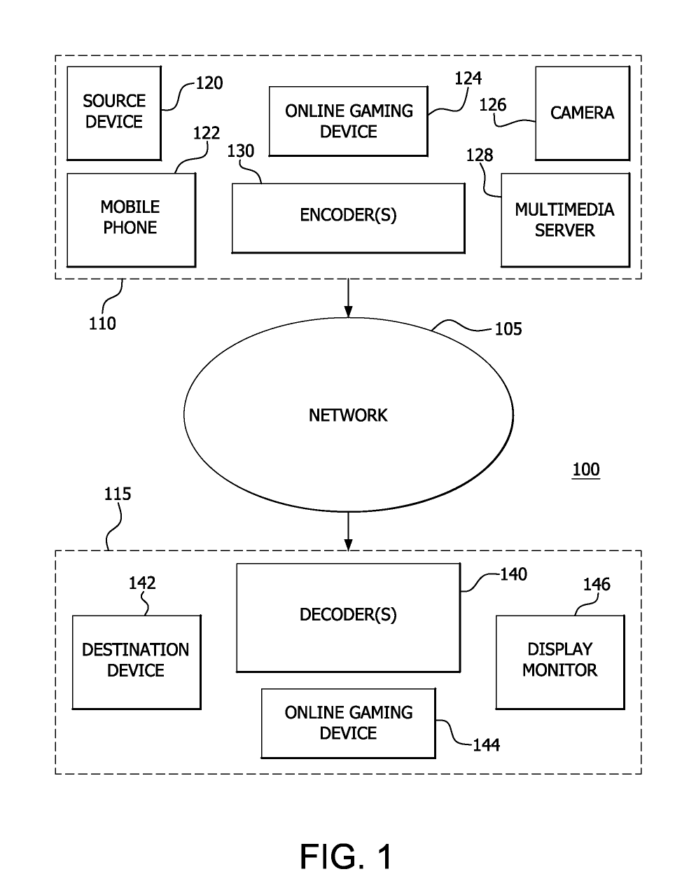

FIG. 1 is an example system 100 that uses high throughput video encoders as described herein below to send encoded video data over a network 105 from a source side 110 to a destination side 115, according to some embodiments. The source side 110 includes any device capable of storing, capturing or generating video data that may be transmitted to the destination side 115. The device may include, but is not limited to, a source device 120, a mobile phone 122, online gaming device 124, a camera 126 or a multimedia server 128. The video data from these devices feeds encoder(s) 130, which in turn encodes the video data as described herein below. The encoded video data is processed by decoder(s) 140, which in turn sends the decoded video data to destination devices, which may include, but is not limited to, destination device 142, online gaming device 144, and a display monitor 146. Although the encoder(s) 130 are shown as a separate device(s), it may be implemented as an external device or integrated in any device that may be used in storing, capturing, generating or transmitting video data.

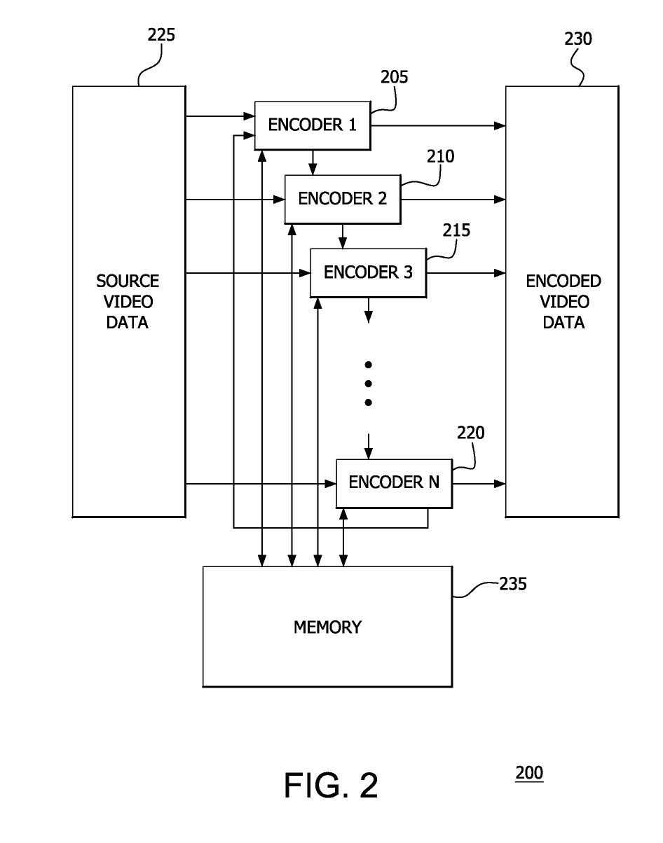

FIG. 2 is a block diagram of an example high throughput video encoder 200, according to some embodiments. The high throughput video encoder 200 may include a plurality of video encoders for receiving video data and outputting encoded video data. Each of the plurality of video encoders is a complete, fixed function, hardware video encoder. For purposes of illustration only, the high throughput video encoder 200 may include video encoder 1205, video encoder 2 210, video encoder 3 215 through video encoder N 220, where video encoder 1 205 is connected to encoder 2 210, video encoder 2 210 is connected to video encoder 3 215 and so on until video encoder N 220, which is connected to video encoder 1 205. Video encoder 1 205, video encoder 2 210, video encoder 3 215 through video encoder N 220 each receive source video data 225 and output encoded video data 230. Each of the video plurality of video encoders is further connected to a common memory for storing and reading reference data as described herein. For example, video encoder 1205, video encoder 2 210, video encoder 3 215 through video encoder N 220 are connected to memory 235.

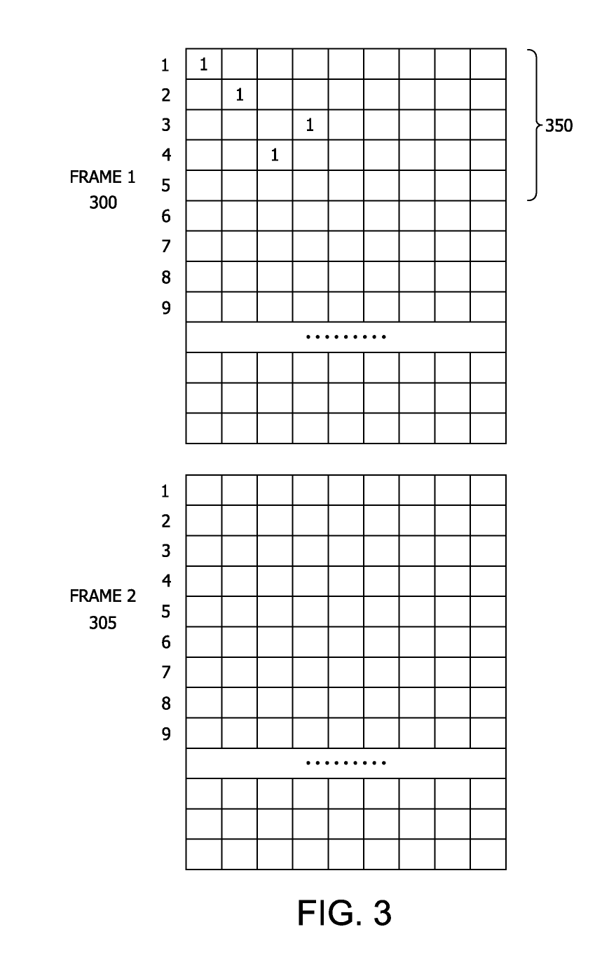

As described herein, the high throughput video encoder may include 2 to N video encoder instances or circuits. Each video encoder instance encodes a video frame, where video data includes multiple video frames. FIG. 3 is an example diagram of a frame 1 300 and a frame 2 305. Each of the frames 300 and 305 contains macroblock rows 1 . . . m, where each macroblock row may have, for example, 8 to 16 raster lines, depending on the video encoding standard or scheme being used.

In standard encoding schemes, there exists a dependency on a previous frame when encoding a current frame. For example, when encoding the current frame, the video encoder uses the reference generated by the previous video frame. To maximize the video encoding throughput, all of the video encoders need to work in parallel without having to wait for other video encoders to completely finish encoding a video frame. This is achieved by having each video encoder wait for a programmable or predetermined number of macroblock rows. In an embodiment, the predetermined number of macroblock rows is less than the total number of macroblock rows in a frame. In another embodiment, the predetermined number of macroblock rows is small with respect to the total number of macroblock rows in a frame. In another embodiment, the predetermined number of macroblock rows may be on the order of 1-10 macroblock rows. This number can be predetermined but can be signaled by the video encoder encoding the previous frame. This method ensures that the video encoder that encodes the previous frame (N-1) finishes generating the reference for the video encoder that encodes the current frame (frame N) needs to use. In this manner, all video encoders are staggered by a few macroblock rows but are working in parallel for maximum throughput.

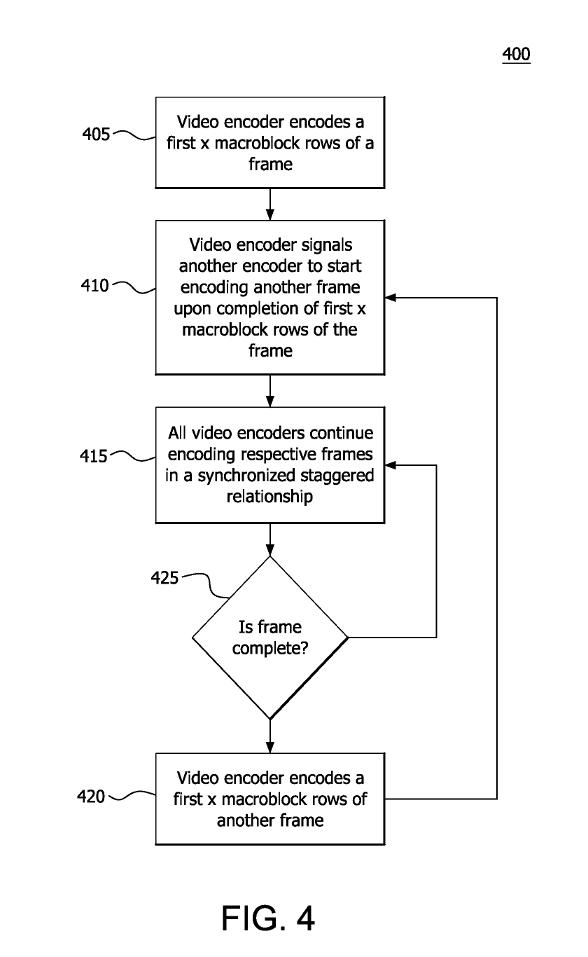

FIG. 4 is an example high level flowchart 400 for a video data using a high throughput video encoder, according to some embodiments. A video encoder encodes a first x macroblock rows of a frame (405). The video encoder signals another video encoder to start encoding a macroblock row of a next unprocessed frame after the first x macroblock rows are complete (410). Both (or all) video encoders continue encoding in parallel (415) in a synchronized staggered manner. If the frame is completed, the video encoder starts encoding x macroblock rows of another unprocessed frame (420). Otherwise, the video encoders continue encoding the frame (425).

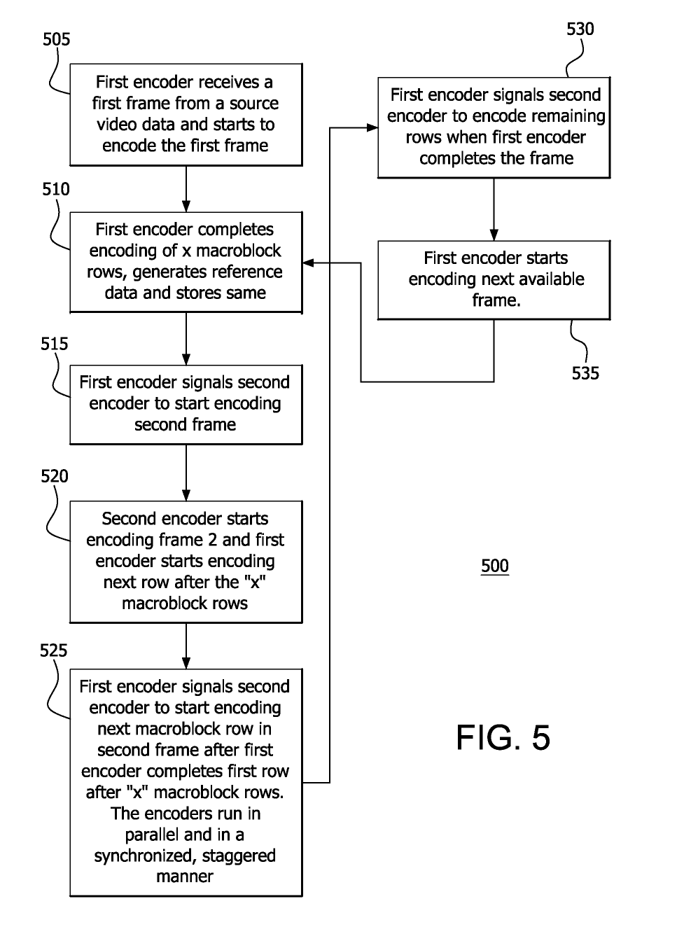

FIG. 5 is an example flowchart 500 for encoding video data using a high throughput video encoder and is also described with reference to FIGS. 2 and 3, according to some embodiments. For purposes of illustration only, the flowchart 500 is described with reference to two video encoders, encoder 1 205 and encoder 2 210, and assumes that the number of macroblock rows is 5 macroblock rows. This is shown in FIG. 2 as macroblock rows 250.

Initially, encoder 1 205 receives a frame 1 300 from the source video data 225 and starts to encode frame 1 300 (505). Encoder 2 210 waits until encoder 1 205 finishes encoding the programmed or predetermined number of macroblock rows, for example, macroblock rows 350. This constitutes the initial delay. Once encoder 1 205 completes encoding macroblock rows 350, encoder 1 205 generates reference data associated with the macroblock rows 350 and stores the reference data in storage, for example, memory 235 (510). Encoder 1 205 signals encoder 2 210 to start encoding macroblock row 1 for frame 2 305 (515).

Encoder 2 210 starts encoding macroblock row 1 of frame 2 305 and in parallel, encoder 1 205 continues to encode the next macroblock row, i.e. macroblock row 6 frame 1 300 (520). When encoder 1 205 finishes encoding macroblock row 6, encoder 1 205 signals encoder 2 210 to start encoding macroblock row 2 of frame 2 305 (525). Due the dependency relationship between encoder 1 205 and encoder 2 210, (i.e. encoder 2 210 needing the reference data from encoder 1 205), encoder 2 210 is always lagging by the predetermined number of macroblock rows but in-step with encoder 1 205. This results in encoder 1 205 and encoder 2 210 operating in parallel in a synchronized, staggered manner. Assuming for purposes of illustration that the frames have a 1920×1088 frame resolution and that each macroblock has 16×16 pixels, when encoder 1 205 finishes encoding macroblock row 67 of frame 1 300, encoder 1 205 signals encoder 2 210 to encode macroblock row 63 of frame 2 305.

Once encoder 1 205 finishes encoding macroblock row 68 of frame 1 305, encoder 1 205 signals encoder 2 210 that encoder 2 210 can encode macroblock rows 64-68 of frame 2 305 since encoder 1 205 has finished generating all the references for frame 1 300 (530). Encoder 1 205 starts encoding frame 3 once macroblock row 68 of frame 1 300 is completed (535). However, encoder 2 210 has to wait for encoder 1 205 to finish encoding the first programmed or predetermined number of macroblock rows of frame 3 before encoder 2 210 can start encoding the next frame, i.e. frame 4.

This method can scale to a large number of video encoders for maximum throughput. After an initialization delay, the long term throughput is N if there are, for example, N video encoders. The initialization delay introduces a fixed amount of stagger or delay for each video encoder. For example, for the Nth video encoder given x as the predefined or programmed number of macroblock rows, then the stagger or delay will be Nx.

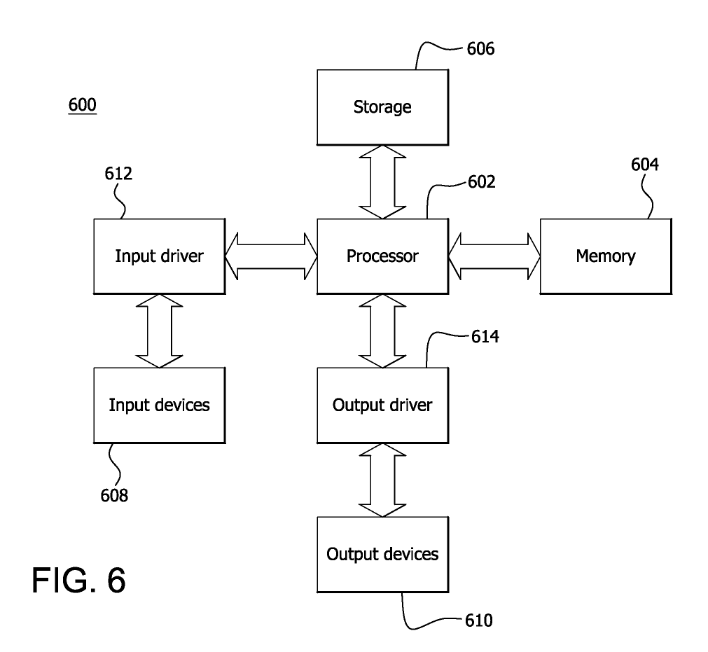

FIG. 6 is a block diagram of a device 600 in which the high throughput video encoders described herein may be implemented, according to some embodiments. The device 600 may include, for example, a computer, a gaming device, a handheld device, a set-top box, a television, a mobile phone, or a tablet computer. The device 100 includes a processor 602, a memory 604, a storage 606, one or more input devices 608, and one or more output devices 610. The device 600 may also optionally include an input driver 612 and an output driver 614. It is understood that the device 100 may include additional components not shown in FIG. 6.

The processor 602 may include a central processing unit (CPU), a graphics processing unit (GPU), a CPU and GPU located on the same die, or one or more processor cores, wherein each processor core may be a CPU or a GPU. The memory 604 may be located on the same die as the processor 602, or may be located separately from the processor 602. The memory 604 may include a volatile or non-volatile memory, for example, random access memory (RAM), dynamic RAM, or a cache. In some embodiments, the high throughput video encoders are implemented in the processor 602.

The storage 606 may include a fixed or removable storage, for example, a hard disk drive, a solid state drive, an optical disk, or a flash drive. The input devices 608 may include a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 610 may include a display, a speaker, a printer, a haptic feedback device, one or more lights, an antenna, or a network connection (e.g., a wireless local area network card for transmission and/or reception of wireless IEEE 802 signals).

The input driver 612 communicates with the processor 602 and the input devices 608, and permits the processor 602 to receive input from the input devices 608. The output driver 614 communicates with the processor 602 and the output devices 610, and permits the processor 602 to send output to the output devices 610. It is noted that the input driver 612 and the output driver 614 are optional components, and that the device 600 will operate in the same manner if the input driver 612 and the output driver 614 are not present.

The video encoders described herein may use a variety of encoding schemes including, but not limited to, Moving Picture Experts Group (MPEG) MPEG-1, MPEG-2, MPEG-4, MPEG-4 Part 10, Windows® *.avi format, Quicktime® *.mov format, H.264 encoding schemes, High Efficiency Video Coding (HEVC) encoding schemes and streaming video formats.

In general, in accordance with some embodiments, a method for encoding includes encoding a frame using an encoder and encoding a next frame using another encoder after the encoder completes encoding a predetermined number of macroblock rows of the frame. The encoder and the another encoder operate in parallel in a synchronized, staggered manner. In some embodiments, the predetermined number of macroblock rows is less than the number of macroblock rows in the frame. In some embodiments, the predetermined number of macroblock rows is on an order of 1-10 macroblock rows.

It should be understood that many variations are possible based on the disclosure herein. Although features and elements are described above in particular combinations, each feature or element may be used alone without the other features and elements or in various combinations with or without other features and elements.

The methods provided, to the extent applicable, may be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors may be manufactured by configuring a manufacturing process using the results of processed hardware description language (HDL) instructions and other intermediary data including netlists (such instructions capable of being stored on a computer readable media). The results of such processing may be maskworks that are then used in a semiconductor manufacturing process to manufacture a processor which implements aspects of the embodiments.

The methods or flow charts provided herein, to the extent applicable, may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method for encoding, comprising:
encoding a frame using a first encoder; and
encoding a next frame using a second encoder after the first encoder completes encoding a predetermined number of macroblock rows of the frame, wherein the first encoder and the second encoder operate in parallel in a synchronized, staggered manner.

2. The method of claim 1, wherein the predetermined number of macroblock rows is less than the number of macroblock rows in the frame.

3. The method of claim 1, wherein the predetermined number of macroblock rows is on an order of 1-10 macroblock rows.

4. The method of claim 1, wherein the first encoder signals the second encoder when to start encoding the next frame.

5. The method of claim 1, wherein the encoder generates reference data for the another encoder and stores the reference data in memory for use by the another encoder.

6. A method for encoding, comprising:
encoding a frame using a first encoder; and
encoding a next frame using a second encoder, wherein the first encoder and the second encoder operate in parallel in a synchronized, staggered manner, wherein the stagger is a predetermined number of macroblock rows.

7. The method of claim 6, wherein the predetermined number of macroblock rows is less than the number of macroblock rows in the frame.

8. The method of claim 6, wherein the predetermined number of macroblock rows is on an order of 1-10 macroblock rows.

9. The method of claim 6, wherein the first encoder signals the second encoder when to start encoding the next frame.

10. The method of claim 6, wherein the first encoder generates reference data for the second encoder and stores the reference data in memory for use by the second encoder.

11. A device, comprising:
a memory;
at least two encoders;
one encoder of the at least two encoders configured to encode a frame; and
another encoder of the at least two encoders configured to encode a next frame after the one encoder completes encoding a predetermined number of macroblock rows of the frame, wherein the one encoder and the another encoder operate in parallel in a synchronized, staggered manner.

12. The device of claim 11, wherein the predetermined number of macroblock rows is less than the number of macroblock rows in the frame.

13. The device of claim 11, wherein the predetermined number of macroblock rows is on an order of 1-10 macroblock rows.

14. The device of claim 11, wherein the one encoder signals the another encoder when to start encoding the next frame.

15. The device of claim 11, wherein the one encoder generates reference data for the another encoder and stores the reference data in the memory for use by the another encoder.

16. A device, comprising:
a memory;
a plurality of encoders;
an encoder of the plurality of encoders configured to encode a frame; and
another encoder of the plurality of encoders configured to encode a next frame, wherein the encoder and the another encoder operate operate in parallel in a synchronized, staggered manner, wherein the stagger is a predetermined number of macroblock rows.

17. The device of claim 16, wherein the predetermined number of macroblock rows is less than the number of macroblock rows in the frame.

18. The device of claim 16, wherein the predetermined number of macroblock rows is on an order of 1-10 macroblock rows.

19. The device of claim 16, wherein the encoder signals the another encoder when to start encoding the next frame.

20. The device of claim 16, wherein the encoder generates reference data for the another encoder and stores the reference data in the memory for use by the another encoder.

21. A system for sending data from a source device to a destination device, comprising:
a memory;
at least two encoders;
one encoder of the at least two encoders configured to encode a frame received from the source device; and
another encoder of the at least two encoders configured to encode a next frame received from the source device after the one encoder completes encoding a predetermined number of macroblock rows of the frame, wherein the one encoder and the another encoder operate in parallel in a synchronized, staggered manner.

22. The system of claim 21, wherein the predetermined number of macroblock rows is less than the number of macroblock rows in the frame.

23. The system of claim 21, wherein the predetermined number of macroblock rows is on an order of 1-10 macroblock rows.

24. The system of claim 21, wherein the one encoder signals the another encoder when to start encoding the next frame.

25. The system of claim 21, wherein the one encoder generates reference data for the another encoder and stores the reference data in the memory for use by the another encoder.

26. A system for sending data from a source device to a destination device, comprising:
a memory;
a plurality of encoders;
an encoder of the plurality of encoders configured to encode a frame received from the source device; and
another encoder of the plurality of encoders configured to encode a next frame received from the source device, wherein the encoder and the another encoder operate in parallel in a synchronized, staggered manner, wherein the stagger is a predetermined number of macroblock rows.

27. The system of claim 26, wherein the predetermined number of macroblock rows is less than the number of macroblock rows in the frame.

28. The system of claim 26, wherein the predetermined number of macroblock rows is on an order of 1-10 macroblock rows.

29. The system of claim 26, wherein the encoder signals the another encoder when to start encoding the next frame.

30. The system of claim 26, wherein the encoder generates reference data for the another encoder and stores the reference data in the memory for use by the another encoder.
